(19) United States
(12) Patent Application Publication
(10) Pub. No.: US 2026/0332489 A1
(43) Pub. Date: Oct. 22, 2026

(54) SYSTEM AND METHOD FOR AUTONOMOUS NOTIFICATION CONTROL USING AN ARTIFICIAL INTELLIGENCE-BASED AGENT

(71) Applicant: BANK OF AMERICA CORPORATION, Charlotte, NC (US)

(72) Inventors: Manjula B., Chennai (IN); Rammohan Chiliveri, Concord, NC (US); Poornima Gayathri Mani, Chennai (IN); Anurajam Rajagopalan, Chennai (IN)

(73) Assignee: BANK OF AMERICA CORPORATION, Charlotte, NC (US)

(21) Appl. No.: 19/183,366

(22) Filed: Apr. 18, 2025

(51) Int. Cl. H04L 41/16; H04L 9/40

(52) U.S. Cl. CPC H04L 41/16; H04L 63/1433

(57) ABSTRACT

Systems, computer program products, and methods are described herein for an automated assessment and classification of notifications generated in a distributed network environment before transmission to an end-point device associated with a user. The present disclosure is configured to: receive a first notification and an associated first communication channel for transmission of the first notification to the user; analyze, using an agentic artificial intelligence (AI) engine, the first notification using classification parameters, wherein the classification parameters are derived by fine-tuning the agentic AI engine using at least one of historical notification data associated with the user, patterns of previous user interactions across multiple communication channels, notification scoring parameters, and anomaly detection criteria; identify the first notification is a non-critical notification based on analyzing the first notification; and block the first notification from transmission to the end-point device of the user upon identifying that the first notification is a non-critical notification.

### TECHNOLOGICAL FIELD

Example embodiments of the present disclosure relate to an automated notification assessment and classification system using an agentic artificial intelligence (AI).

### BACKGROUND

In modern digital ecosystems, users receive a high volume of notifications across various communication channels, including email, SMS, application alerts, and voice interfaces. While some notifications are time-sensitive or require immediate attention, others may be redundant, irrelevant, or inconsistent with user expectations. Additionally, the processing and delivery of unnecessary or low-value notifications can result in resource inefficiency, including wasted computational bandwidth, communication overhead, and increased storage and logging demands. The overwhelming volume of undifferentiated notifications can lead to user disengagement, missed high-priority messages, or diminished confidence in the institution or organization responsible for sending the notifications.

Accordingly, there is a need for an intelligent notification controlling system capable of evaluating incoming notifications and controlling delivery of incoming notification to users.

### BRIEF SUMMARY

Systems, methods, and computer program products are provided for an automated notification assessment and classification. The invention provides the systems, computer program products, and methods comprising: a memory device with computer-readable program code stored thereon; and a processing device operatively coupled to the memory device, wherein executing the computer-readable program code causes the processing device to, and the computer program product comprising at least one non-transitory computer-readable medium having computer-readable program code portion embodied therein, the computer-readable program code portions which when executed by a processing device are configured to cause a processor to: receive a first notification and an associated first communication channel for transmission of the first notification to the user; analyze, using an agentic artificial intelligence (AI) engine, the first notification using classification parameters, wherein the classification parameters are derived by fine-tuning the agentic AI engine using at least one of historical notification data associated with the user, patterns of previous user interactions across multiple communication channels, notification scoring parameters, and anomaly detection criteria; identify the first notification is a non-critical notification based on analyzing the first notification; and block the first notification from transmission to the end-point device of the user upon identifying that the first notification is a non-critical notification.

In some embodiments, the computer-readable program code, when executed, further causes the processing device to: receive a second notification and an associated second communication channel for transmission of the second notification to the user; analyze, using the agentic AI engine, the second notification using the classification parameters; identify the second notification is an anomalous notification based on analyzing the second notification; and transmit the second notification to the end-point device of a subject matter expert (SME) for verification.

In some embodiments, the computer-readable program code, when execute, further causes the processing device to: receive, from the end-point device of the SME, an SME input indicating whether the anomalous notification is suspicious; and block the second notification from transmission to the end-point device of the user in an instance in which the anomalous notification is suspicious.

In some embodiments, the computer-readable program code, when executed, further causes the processing device to transmit the second notification to the end-point device of the user via the associated second communication channel in an instance in which the SME input indicates that the anomalous notification is not suspicious.

In some embodiments, the computer-readable program code, which when executed, further causes the processing device to fine-tune the agentic AI engine using the SME input.

In some embodiments, the computer-readable program code, which when executed, further causes the processing device to: receive a third notification and an associated third communication channel for transmission of the third notification to the user; analyze, using the agentic AI engine, the third notification using the classification parameters; identify the third notification is transmit-ready for transmission via the associated third communication channel based on analyzing the third notification; and transmit the third notification to the end-point device of the user via the associated third communication channel upon determining that the third notification is transmit-ready.

In some embodiments, the computer-readable program code, when executed, further causes the processing device to: receive, from the end-point device of the user, user feedback associated with the transmission of the third notification via the third communication channel; and fine-tune the agentic AI engine using the received user feedback.

In some embodiments, the computer-readable program code, when executed, further causes the processing device to: receive a fourth notification and an associated fourth communication channel for transmission of the fourth notification to the user; analyze, using the agentic AI engine, the fourth notification using the classification parameters; identify the fourth notification is duplicative based on analyzing the fourth notification; and delay transmission of the fourth notification to the end-point device of the user for a predetermined time upon determining that the fourth notification is duplicative.

In some embodiments, the communication channel comprises at least one of an email channel, short messages service (SMS), push notification, voice call, or In-application notification.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made to the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for an automated notification assessment and classification, in accordance with an embodiment of the disclosure.

FIG. 2 illustrates an exemplary machine learning (ML) subsystem architecture, in accordance with an embodiment of the disclosure.

FIG. 3 illustrates a process flow for an automated notification assessment and transmission, in accordance with an embodiment of the disclosure.

FIG. 4 illustrates a process flow for a notification classification and feedback, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be a client of the entity or enterprises affiliated with the entity.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, identifiers such as “first,” “second,” “third,” and/or the like do not indicate a temporal relationship, unless explicitly stated. Such identifiers may modify instances of similar things and may be used to differentiate between each of the instances.

As used herein, an “engine” may refer to core elements of an application, or part of an application that serves as a foundation for a larger piece of software and drives the functionality of the software. In some embodiments, an engine may be self-contained, but externally controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

The present disclosure relates to an automated notification assessment and classification system configured to evaluate, categorize, and control the transmission of notifications across multiple communication channels. The system uses machine learning techniques, including agentic artificial intelligence (AI), to analyze incoming notifications in real time, determine their contextual relevance, urgency, or potential redundancy, and categorize them into actionable types, such as transmit-ready, anomalous, non-critical, or duplicative. The classification process may incorporate predefined system rules, user-specific interaction data, real-time feedback, and contextual signals to optimize notification delivery. By intelligently filtering or deferring irrelevant or duplicative messages, the system reduces notification fatigue, preserves system resources, and ensures that high-priority notifications are prioritized for delivery.

The disclosed system provides a technical improvement in the field of automated notification processing by introducing a machine-learning-based agentic AI engine. Traditional notification systems typically operate based on predefined rules (e.g., limiting the number of total notifications per day) or manual configurations, which can result in excessive or irrelevant notifications being delivered to users. This inefficiency not only leads to communication overload at the user interface level but also consumes unnecessary computational and network resources.

By contrast, the present system uses agentic AI and reinforcement learning models to intelligently classify notifications into categories, such as transmit-ready, anomalous, non-critical, and duplicative. These classifications are determined through autonomous learning from user activity patterns and responses, historical outcomes, and contextual signals. The system further oversees notification delivery across multiple communication channels (e.g., mobile push, email, in-app messaging) to ensure appropriate routing based on user context and device availability. In doing so, the system acts as a centralized notification control mechanism that reduces the need for redundant processing by individual communication platforms, thereby conserving computing and network resources. Additionally, the system dynamically adapts its classification and delivery logic based on user inquiries or feedback, enabling continuous optimization of notification relevance, delivery timing, and resource utilization. As a result, only relevant and high-priority notifications are routed for delivery, while others are filtered or deprioritized, ensuring efficient and targeted communication across all delivery endpoints.

This technical approach reduces the number of processing steps, conserves CPU and memory usage, and minimizes network load associated with redundant or irrelevant message delivery. By centralizing notification logic and dynamically adjusting its decision-making process based on observed user activity patterns and contextual relevance, the system further eliminates the need for manual configuration or fragmented handling across separate communication tools. By adapting its classification logic over time, the system enhances accuracy and delivery efficiency, providing a tangible technical improvement over static rule-based solutions. This represents a significant advancement in notification management and automated decision-making systems.

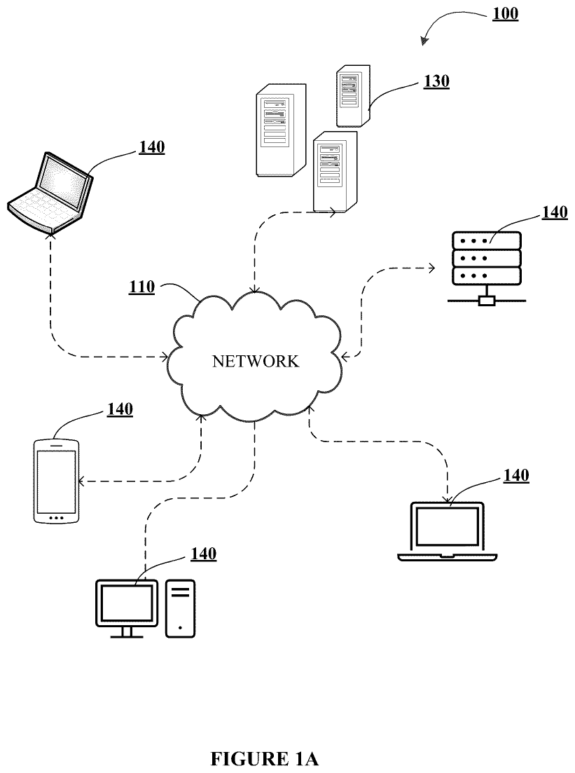

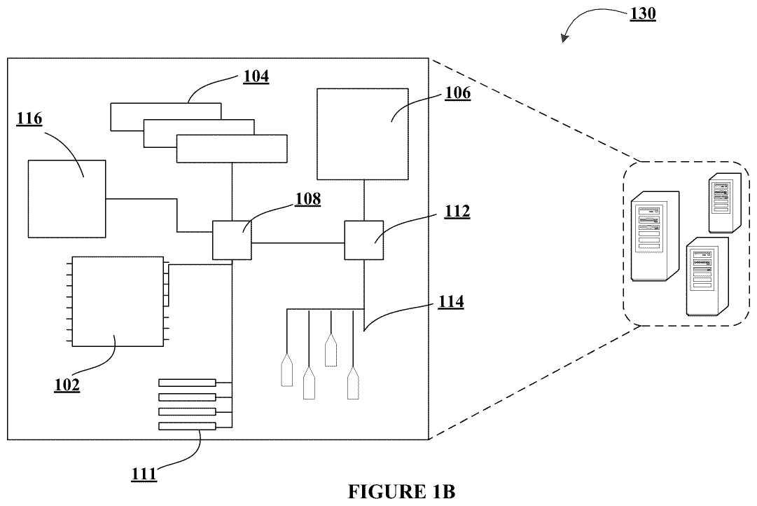

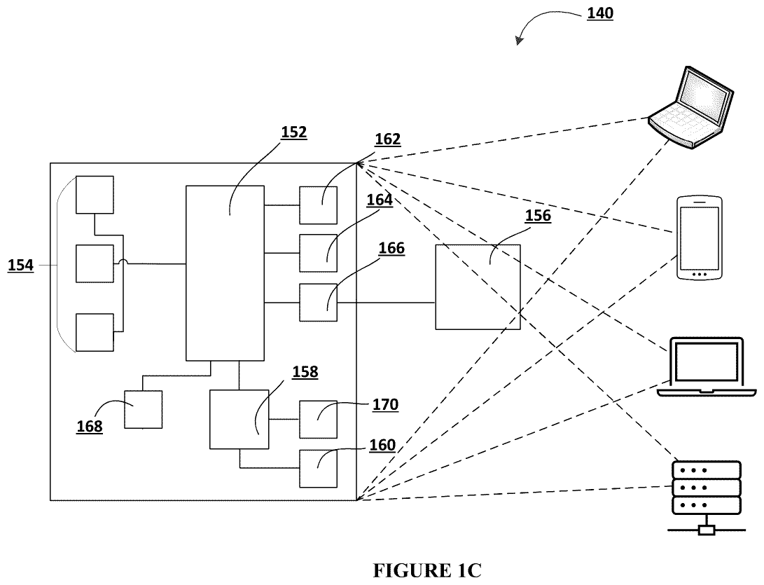

FIGS. 1A-1C illustrate technical components of an exemplary distributed computing environment 100 for an automated notification assessment and classification system, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, tablets, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 106. The system 130 may also include a high-speed interface 108 connecting to the memory 104, and a low-speed interface 112 connecting to low speed bus 114 and storage device 106. Each of the components 102, 104, 106, 108, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

In some embodiments, an automated notification assessment and classification system is configured to use one or more components, or a combination of components, of the system 130 to perform an automated notification control process. The automated notification assessment and classification system may be implemented as one or more software modules, machine learning engines, and data processing components that execute within the computing environment of system 130. These components may reside in the memory 104 or storage device 106, and be executed by the processor 102, allowing the system 130 to perform advanced evaluation of inbound notifications prior to delivery to an end-point device 140. The system 130 may host various components of the system, comprising a notification generation engine, an agentic AI engine, a classification parameter database, a rule engine, a notification repository database, and an inter-process communication interface. These components may be executed on processor 102 and may utilize memory 104 and storage device 106 for model execution, data retrieval, policy evaluation, and persistent logging. The notification generation engine may construct notification objects based on system events, user activity, or external triggers, while the agentic AI engine may be configured to analyze and classify the notifications according to dynamically updated classification parameters. These engines may communicate internally via inter-process communication (IPC) channels or message queues, allowing for asynchronous processing of notifications.

Each component of the automated notification assessment and classification system may be implemented using the hardware infrastructure of system 130. For example, processor 102 may be configured to execute the agentic AI engine, which may comprise or be associated with an AI model trained to perform notification assessment and classification tasks using reinforcement learning, pattern recognition, anomaly detection, and relevance scoring. The AI model may be loaded and executed in real time by processor 102, with memory 104 used to store model weights, classification parameters, and runtime input features. The high-speed interface 108 may facilitate rapid access between the agentic AI engine and memory 104, enabling low-latency processing of incoming notifications and user interaction signals. Storage device 106 may store AI model artifacts, version-controlled rule sets, historical classification results, user engagement logs, and SME feedback records used for continuous learning and tuning of the agentic AI engine. Lower-bandwidth operations, such as notification logging or policy updates, may be managed via the low-speed controller 112 and associated low-speed expansion port 114. The notification generation engine may also be executed by processor 102 and may retrieve or apply message templates, personalization rules, and delivery instructions using data stored in memory 104 and storage device 106.

Communication between internal subsystems may occur through shared buses or inter-process communication (IPC) channels, such as message queues, shared memory regions, or lightweight service calls (e.g., gRPC or RESTful APIs), managed via I/O device 116. External communication to systems such as IVR platforms, user service modules, or third-party notification triggers may occur over network 110 using application-layer protocols over TCP/IP or higher-level communication frameworks such as message brokers, API gateways, or event-driven messaging interfaces.

In some embodiments, data exchanges between internal and external components may be secured using authentication protocols and encryption and may be subject to access controls based on device configurations or policy constraints. This architecture enables real-time generation, classification, and delivery of intelligent notifications by using the distributed processing capabilities of system 130 and contextual input from end-point device(s) 140. The modular design supports scalability across enterprise environments, cloud-based deployments, or hybrid systems, and allows integration with external services and infrastructure through well-defined interfaces and extensible communication patterns.

The classification parameter database may store fine-tuned parameters derived from user history, interaction patterns, and SME feedback, and may be continuously updated through a feedback learning loop. In some embodiments, this database may be implemented using storage device 106 of system 130 and accessed by the agentic AI engine via processor 102 and memory 104 during classification operations. A rule engine may support predefined policies and compliance constraints used by the agentic AI engine during classification and may also be stored on storage device 106, with execution managed by processor 102 and temporary rule loading performed via memory 104. The notification repository database may maintain records of previously generated, transmitted, suppressed, or flagged notifications for auditing and model retraining purposes, and may similarly utilize storage device 106 for persistent logging and retrieval, with access coordinated through the low-speed controller 112. In some embodiments, external systems, such as user service platforms, IVRs, monitoring systems, or notification-triggering systems, may reside outside the automated notification assessment and classification system but interact with it via network 110 using APIs, webhooks, or messaging protocols. Communication between internal components of system 130 and with external systems may be managed through I/O device 116 and network adapters, and may be secured using authentication mechanisms and access controls to preserve data integrity, compliance, and traceability.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

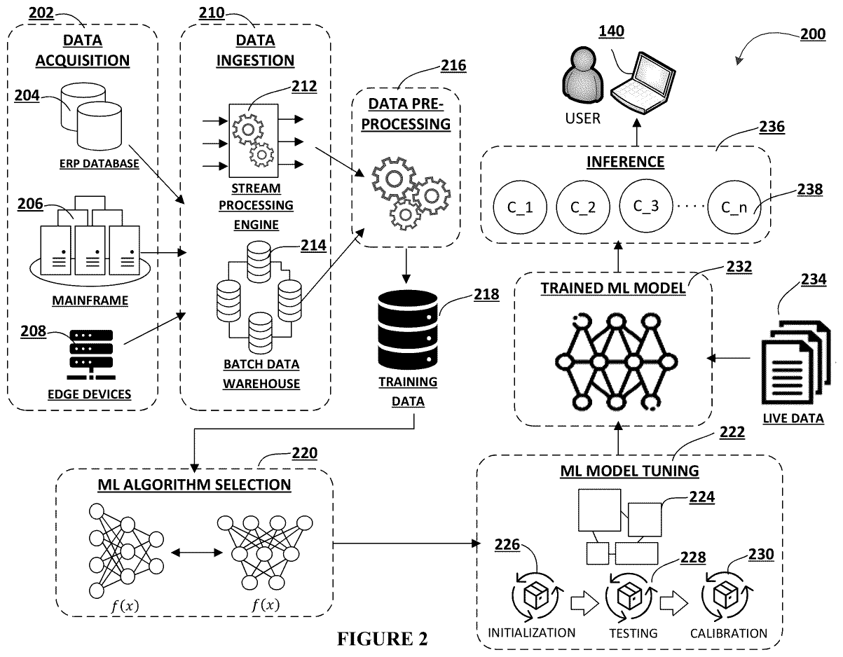

FIG. 2 illustrates an exemplary machine learning (ML) subsystem architecture 200, in accordance with an embodiment of the invention. The machine learning subsystem 200 may include a data acquisition engine 202, data ingestion engine 210, data pre-processing engine 216, ML model tuning engine 222, and inference engine 236.

The data acquisition engine 202 may identify various internal and/or external data sources to generate, test, and/or integrate new features for training the machine learning model 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In machine learning, the quality of data and the useful information that can be derived therefrom directly affects the ability of the machine learning model 224 to learn. The data pre-processing engine 216 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of machine learning algorithm being used, this training data 218 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 222 may be used to train a machine learning model 224 using the training data 218 to make predictions or decisions without explicitly being programmed to do so. The machine learning model 224 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, or the like), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, or the like), an instance-based method (e.g., k-nearest neighbor, learning vector quantization, self-organizing map, or the like), a regularization method (e.g., ridge regression, least absolute shrinkage and selection operator, elastic net, or the like), a decision tree learning method (e.g., classification and regression tree, iterative dichotomiser 3, C4.5, chi-squared automatic interaction detection, decision stump, random forest, multivariate adaptive regression splines, gradient boosting machines, or the like), a Bayesian method (e.g., naïve Bayes, averaged one-dependence estimators, Bayesian belief network, or the like), a kernel method (e.g., a support vector machine, a radial basis function, or the like), a clustering method (e.g., k-means clustering, expectation maximization, or the like), an associated rule learning algorithm (e.g., an Apriori algorithm, an Eclat algorithm, or the like), an artificial neural network model (e.g., a Perceptron method, a back-propagation method, a Recurrent Neural Network (RNN) method, a Hopfield network method, a self-organizing map method, a learning vector quantization method, or the like), a deep learning algorithm (e.g., a restricted Boltzmann machine, a deep belief network method, a convolution network method, a stacked auto-encoder method, or the like), a dimensionality reduction method (e.g., principal component analysis, partial least squares regression, Sammon mapping, multidimensional scaling, projection pursuit, or the like), an ensemble method (e.g., boosting, bootstrapped aggregation, AdaBoost, stacked generalization, gradient boosting machine method, random forest method, or the like), and/or the like.

To tune the machine learning model, the ML model tuning engine 222 may repeatedly execute cycles of experimentation 226, testing 228, and tuning 230 to optimize the performance of the machine learning algorithm 220 and refine the results in preparation for deployment of those results for consumption or decision making. To this end, the ML model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and model accuracy maximized.

The trained machine learning model 232, similar to any other software application output, can be persisted to storage, file, memory, or application, or looped back into the processing component to be reprocessed. More often, the trained machine learning model 232 is deployed into an existing production environment to make practical business decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 130. In still other cases, machine learning models that perform regression techniques may use live data 234 to predict or forecast continuous outcomes.

The automated notification assessment and classification system is configured to utilize an agentic artificial intelligence (AI) to control the notification process. As used herein, agentic AI refers to an AI system or model that exhibits autonomous, goal-directed behavior by perceiving its environment, making decisions, and executing actions without requiring explicit instructions for every task. Unlike traditional AI systems that respond to predefined inputs with fixed outputs, agentic AI systems are designed to act as intelligent agents that are capable of initiating processes, adapting to new information, and learning from outcomes over time. In some embodiments, agentic AI may incorporate various technologies such as machine learning, reinforcement learning, feedback loops, and multi-modal input processing to understand context, determine intent, and adjust its behavior dynamically. The agentic AI system may interact with users or other systems, perform complex tasks across different environments, and evolve based on both structured rules and learned patterns.

In some embodiments, the machine learning model 224 may be implemented as an agentic AI model that is configured to operate with goal-directed autonomy, contextual awareness, and adaptive behavior. The agentic AI model may be trained using a multi-phase training process that includes a base training phase and a fine-tuning phase, allowing the model to learn general-purpose capabilities and subsequently specialize in task-specific or user-specific functions.

During the base training phase, the agentic AI model may be exposed to large-scale, diverse datasets derived from internal and external data sources 204, 206, and 208 via the data acquisition engine 202 and processed through the data ingestion engine 210. These datasets may include text, system events, user interactions, temporal signals, and behavioral sequences across multiple modalities. The data pre-processing engine 216 may prepare this training data using transformation, normalization, feature extraction, and data labeling operations to generate foundational training data 218. The base training enables the agentic AI model to develop broad contextual understanding, general reasoning capabilities, and basic behavioral patterns across environments.

Following the base training phase, the fine-tuning phase may be performed by the ML model tuning engine 222 to align the agentic AI model with domain-specific objectives, environmental constraints, or user interaction patterns. In some embodiments, fine-tuning may involve supervised learning using labeled training data, reinforcement learning using environmental feedback, or iterative feedback learning based on real-time interactions with user input systems 130. The model tuning engine 222 may execute cycles of experimentation 226, testing 228, and tuning 230 to optimize hyperparameters and decision weights of the agentic AI model to improve task performance, response accuracy, and contextual adaptability.

In some embodiments, the agentic AI model may incorporate a combination of the machine learning algorithm 220 and reasoning-based algorithms to support autonomous analysis, classification, and filtering of incoming notifications. The agentic AI model may be configured to continuously observe user interaction patterns, assess contextual relevance, and adapt its classification parameters through dynamic learning processes. To support autonomous filtering and classification, the agentic AI may utilize reinforcement learning (RL) algorithms, such as Q-learning, deep Q-networks (DQNs), proximal policy optimization (PPO), and/or the like, to evaluate and refine decision-making strategies based on historical outcomes and user feedback. These algorithms may enable the AI to learn optimal classification and routing actions, such as labeling a notification as “transmit-ready,” “suspicion-flagged,” “non-critical,” or “duplicative,” based on long-term reward signals that reflect user engagement or satisfaction.

In various implementations, the system may further utilize supervised learning models, comprising logistic regression, decision trees, random forests, neural networks, and/or the like, trained using labeled notification records. Unsupervised models, such as k-means clustering principal component analysis (PCA), and/or the like, may be used to uncover latent structure in unlabeled data, while semi-supervised models may combine both labeled and unlabeled datasets to enhance performance. The agentic AI may also implement deep learning models, such as convolutional neural networks (CNNs), recurrent neural networks (RNNs), and/or the like, for temporal or sequence-based analysis of user interactions or notification history. Transformer-based natural language processing (NLP) models may be employed for semantic evaluation of notification content, enabling capabilities, such as intent detection, topic classification, and sentiment analysis, thereby allowing the system to match tone and relevance with user expectations or current state. For anomaly detection or duplicative message suppression, the agentic AI may incorporate isolation forests, autoencoder-based detectors, rule-based inconsistency checks, and/or the like, configured to identify notifications that are redundant, irrelevant, or inconsistent with prior messages.

Additionally, the AI engine may employ user interaction modeling through supervised or semi-supervised learning to infer and continuously update user preferences. This may include learning patterns tied to channel-specific responsiveness, timing sensitivities, and content-based priorities. Feedback learning loops may be integrated into the classification cycle, wherein implicit (e.g., message ignored) or explicit (e.g., message marked as spam) user feedback is used to refine thresholds, weightings, or classification features. In some embodiments, the AI engine may further implement online learning, contextual bandits, or adaptive ensemble techniques to enable real-time personalization based on shifting user behavior or evolving communication formats. The overall algorithmic framework may be dynamically optimized for classification accuracy, delivery timing, and contextual alignment across communication channels, ensuring the system adapts effectively to personalized user behavior and notification ecosystems.

Upon completion of the fine-tuning phase, the fully trained agentic AI model 232 may be deployed to the inference engine 236 to make real-time autonomous decisions based on live data 234. In some embodiments, the agentic AI model may determine optimal actions, classification labels, or policy-driven outputs (e.g., C₁, C₂, . . . Cₙ 238) by interpreting live inputs and evaluating them against contextual rules, prior knowledge, and learned behavioral patterns. The decision outputs may be continuously refined by incorporating performance feedback, thereby enabling the agentic AI model to evolve over time and remain aligned with operational goals, user expectations, or system-defined constraints.

It will be understood that the embodiment of the machine learning subsystem 200 illustrated in FIG. 2 and the agentic AI are exemplary and that other embodiments may vary. As another example, in some embodiments, the machine learning subsystem 200 and the agentic AI may include more, fewer, or different components.

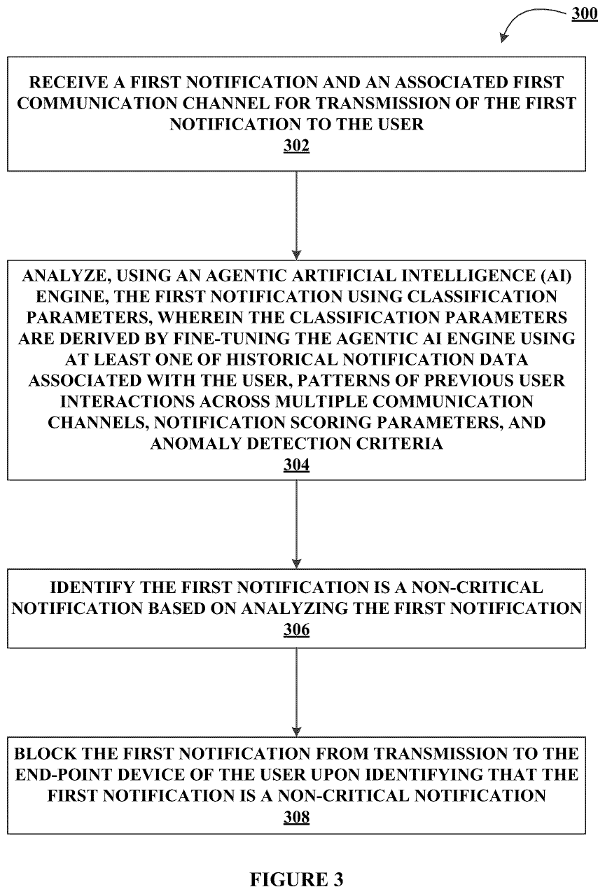

FIG. 3 illustrates a process flow 300 for automated notification assessment and transmission, in accordance with an embodiment of the disclosure. In some embodiments, the automated notification assessment and classification system may perform one or more of the steps of process flow 300.

As shown in block 302, the process flow 300 may include the step of receiving a first notification and an associated first communication channel for transmission of the first notification to the user. In example embodiments, the agentic AI engine may be configured to receive one or more notifications and associated communication channels, including the first notification and an associated first communication channel, generated by a notification generation engine.

In some embodiments, a notification may be generated by a notification generation engine before being transmitted to the user via an associated communication channel. The notification generation engine may be implemented as a component of the automated notification assessment and classification system and operate within the system 130. The engine is configured to create, compile, or construct one or more notification objects based on operational events, user activity data, predefined rules, notification rulesets, or external data sources. The notification objects may comprise structured content, contextual metadata, and delivery parameters, such as status updates, alerts, reminders, confirmations, marketing content, or system recommendations. The notification generation engine may operate independently or in conjunction with other user-service systems in the system 130 to determine when a notification should be generated, what content it should include, and which communication channel(s) should be used for delivery.

In some embodiments, the system 130 may comprise multiple notification generation engines or similar subsystems deployed across various nodes or regions of the distributed computing environment 100. Each notification generation engine may be independently configured to monitor local events, system activities, or external triggers and to generate corresponding notification objects. The presence of multiple such engines may facilitate scalability and parallelized notification handling across the distributed computing environment 100. In some embodiments, one or more of the notification generation engines may reside external to the automated notification assessment and classification system but remain operatively integrated within the system 130. In such configurations, a notification generation engine may be associated with, or embedded within, a notification-triggering subsystem and may be configured to construct notification objects in response to external events, rule-based logic, or system-defined conditions. The generated notification objects may be transmitted to the automated notification assessment and classification system prior to delivery to the end-point device, using the network 110 or one or more inter-system communication interfaces, such as TCP/IP protocols or higher-layer messaging frameworks, for downstream processing and classification.

In some embodiments, the notification generation engine may interface with user data repositories, event logs, transaction records, or monitoring sub systems to retrieve relevant information used in composing the notification. The notification generation engine may be further configured to template logic, format rules, or priority tag to structure the notification in a format suitable for downstream processing or user delivery. The generated notification is transmitted to the automated notification assessment and classification system for analysis and categorization prior to transmission to an end-point device via an associated communication channel.

As used herein, “communication channel” may refer to a pathway or medium through which notifications or messages are transmitted from the automated notification assessment and classification system to end-point devices or user interfaces. The communication channels may include, but are not limited to, email, SMS, push notifications, in-application (in-app) messaging, voice calls, instant messaging platforms, secured web portals, and/or the like. The communication channels may support unidirectional or bidirectional communication, enabling the delivery of notifications and the receipt of user acknowledgments, responses, or feedback. In some embodiments, each communication channel is associated with one or more formatting specifications, security protocols, and delivery confirmation mechanisms configured to ensure proper content rendering, regulatory or organizational compliance, and transmission traceability.

As shown in block 304, the process flow 300 may include the step of analyzing, using an agentic artificial intelligence (AI) engine, the first notification using classification parameters, wherein the classification parameters are derived by fine-tuning the agentic AI engine using at least one of historical notification data associated with the user, patterns of previous user interactions across multiple communication channels, notification scoring parameters, and anomaly detection criteria. In example embodiments, the automated notification assessment and classification system is configured to utilize an agentic AI engine to process notification control for the received one or more notifications, including the first notification, generated for the user. The agentic AI engine is base-trained and fine-tuned prior to deployment for the automated notification control process.

In some embodiments, the agentic artificial intelligence (AI) engine may be processed with a base training phase to establish foundational learning capabilities for automated notification assessment and classification. during a base training phase, the agentic AI model may be trained using broad, domain-agnostic datasets configured to enable the model to develop a generalized understanding of natural language processing, sequential prediction, temporal pattern recognition, and adaptive decision-making. The base training may incorporate a variety of input formats, including unlabeled communication data, publicly available textual corpora, structured system log data, and synthetically generated event sequences. The training is configured to enable the AI model to interpret multi-modal inputs and perform foundational classification operations.

In some embodiments, the training may be performed using supervised learning, unsupervised learning, or reinforcement learning techniques, depending on the architectural design of the agentic AI model. For example, recurrent neural networks (RNNs), transformer-based architectures, or other neural network models may be employed to develop baseline capabilities for processing sequential data, recognizing linguistic patterns, detecting anomalies, and inferring user intent. Furthermore, the base training process may enable the agentic AI engine to learn general communication patterns, event-to-response correlations, and fundamental operational principles associated with digital notification environments. Upon completion of the base training phase, the AI model may be configured with generalized inference capabilities, enabling subsequent fine-tuning using domain-specific datasets, contextual classification rules, and user-aligned activity models for deployment within the agentic AI engine.

In some embodiments, following completion of the base training phase, the agentic AI engine may be processed through a fine-tuning phase to generate classification parameters, wherein the AI model is adapted to execute automated notification assessment and classification processes within a specified operational domain. During the fine-tuning phase, the AI model may be trained using a large-scale dataset comprising historically labeled notification records, simulated user interactions, and representative feedback signals. The dataset may comprise a range of notification types, such as transactional alerts, marketing messages, informational updates, and security warnings, each annotated with contextual classifications (e.g., high-priority, low-priority, suspicious, redundant, or irrelevant). The fine-tuning process enables the AI model to learn domain-specific classification patterns and contextual notification dynamics applicable to real-world scenarios.

In some embodiments, the AI model may be fine-tuned using historical notification data associated with the user, comprising records and metadata derived from prior notifications sent to an individual user. Such data may include: frequency information representing the time intervals and frequency at which notifications have been previously sent; user response behavior, including user engagement rates, such as whether notifications were opened, acknowledged, ignored, or explicitly marked as unnecessary; notification content, including specific content or templates historically transmitted to the user, categorized by message type (e.g., informational, transactional, promotional, or alert-related); and user preferences, including historical acceptance or explicit user-set preferences for the types, frequency, or timing of notifications. The historical data may be used to tailor the agentic AI engine's classification process to reflect individualized engagement patterns and context-sensitive communication expectations.

The fine-tuning process may incorporate patterns of previous user interactions across multiple communication channels, referring to the analysis of user activity across distinct communication platforms, such as email, SMS, chat, voice, or in-app notifications. The analysis may include identification of channel preferences, wherein the system determines which communication channels are favored based on historical user responsiveness. Additionally, the AI model may be configured to evaluate channel-specific interaction trends, such as identifying that a user is more likely to respond to notifications delivered via SMS as opposed to email. The AI model may further be configured to detect cross-channel engagement patterns, comprising sequential or concurrent user interactions across multiple communication channels, which may be indicative of user expectations or behavioral preferences with respect to the receipt and engagement of notifications.

Additionally, the agentic AI engine may be fine-tuned using one or more notification scoring parameters that apply linguistic analysis, contextual semantics, and natural language processing (NLP) techniques to evaluate the relevance of notification content. The notification scoring parameters may include semantic context analysis that evaluates notification content with respect to the current situational context, such as ongoing transactions, user inquiries, or support cases. The engine may use user intent detection by applying machine learning algorithms to interpret intent derived from user communications, thereby assessing the appropriateness or necessity of the notification. Topic and sentiment analysis may further be applied to identify subjects and emotional tone historically expressed by the user, enabling accurate alignment between notification content and the user's interests, sentiments, and contextual needs.

The fine-tuning process may further incorporate anomaly detection criteria configured to identify and filter out notifications that may diminish relevance or contribute to user confusion. The anomaly detection criteria may comprise redundancy criteria configured to determine whether a notification duplicates previously transmitted messages or conveys identical or substantially similar information within short time intervals. The AI model may further apply irrelevance criteria to detect notifications that lack alignment with the current user context, preferences, or historical interactions, including messages characterized by contextual mismatches or low semantic relevance scores. Additionally, the system may implement inconsistency criteria to identify conflicting messages, including notifications that contradict prior communications, violate user-defined settings, or deviate from established communication policies, any of which may negatively impact user confidence or result in interpretive ambiguity.

In some embodiments, a notification repository database is configured to store historical records associated with notifications transmitted to one or more users. The stored data may be structured to support fine-tuning and classification operations performed by the agentic AI engine. The notification repository database may include, for each user, metadata and content related to previously transmitted notifications, user response interactions, engagement metrics, communication channel usage, and contextual delivery parameters. The agentic AI engine may be configured to access the notification repository database to retrieve such information for use in evaluating historical notification data associated with the user, identifying patterns of previous user interactions, supporting application of notification scoring parameters, and serving as a historical reference for identifying anomaly detection criteria.

In some embodiments, the fine-tuning process of the agentic AI engine may be further configured to incorporate additional contextual and policy-driven inputs, including but not limited to structured rule sets derived from a rule engine, domain-specific operational guidelines retrieved from a prior knowledge repository, event-triggered observational data, and real-time user interaction inputs. The rule engine may be configured to store one or more notification governance rules, such as notification transmission policies, user-facing delivery constraints, and industry-specific compliance requirements (e.g., financial disclosure obligations, suspicious activity alert procedures, and/or the like). The agentic AI engine may be configured to utilize these rules to align classification behavior with organizational protocols and applicable regulatory standards. The fine-tuning process may further configured to reference prior knowledge comprising known patterns, historical workflows, or heuristic methods designed for evaluating and classifying notifications. Prior knowledge may support baseline strategies for notification handling based on established best practices, user behavior templates, and domain-specific operational logic. Observational data may include detection and classification of events or triggers resulting in notification generation. Such data may include characteristics of the originating event (e.g., a completed transaction, system alert, user inquiry, or workflow trigger) and metadata associated with event timing, source system identity, and contextual state. These inputs may enable the agentic AI engine to infer the likely intent and urgency of a notification within a broader operational context.

Furthermore, the fine-tuning process may be enhanced through real-time user interaction data, comprising active communications between the user and interactive voice response (IVR) systems, chatbots, or agentic digital assistants. User interactions may be captured and analyzed to extract intent, confirm relevance of transmitted notifications, or collect implicit feedback. The agentic AI engine may be configured to process real-time interaction data to refine classification logic dynamically, enabling adjustments to sensitivity levels, prioritization strategies, or contextual weighting factors in response to evolving behavioral indicators.

Through integration of fine-tuning data sources and classification signals, the agentic AI engine may develop personalized, context-aware classification capabilities adapted to individual user activity patterns and dynamically changing notification environments. Upon completion of the fine-tuning phase, the agentic AI engine may be configured to analyze incoming notifications using updated classification parameters to determine relevance, urgency, or categorical designation prior to transmission to the user.

As shown in block 306, the process flow 300 may include the step of identifying the first notification is a non-critical notification based on analyzing the first notification. In example embodiments, the agentic AI engine may be configured to analyze one or more of the received notifications, including the first notification, and classify each notification into one of the following categories: a transmit-ready notification, an anomalous notification, a non-critical notification, or a duplicative notification. In this example, the first notification is identified as a non-critical notification based on the classification process.

A transmit-ready notification may refer to a notification that satisfies predefined criteria for relevance, urgency, and clarity, thereby qualifying the notification for immediate delivery to the user through an associated communication channel. An anomalous notification refers to a message that deviates from expected patterns or content norms, potentially indicating irregular data, an unexpected system event, or activity occurring outside typical operational boundaries. The anomalous notification classification may also comprise notifications that exhibit characteristics suggestive of irregular, manipulated, or potentially misleading content, such as notifications generated under unusual conditions or containing attributes that raise concern regarding authenticity or origin. A non-critical notification may refer to a notification identified as low priority or informational content that does not require immediate user attention and may be delayed, deprioritized, silently logged, or blocked. A duplicative notification may refer to a notification that substantially overlaps with or repeats content from a previously delivered or queued notification, and may be suppressed to reduce redundancy and prevent notification fatigue for the user. The system may react differently based on the classification, such as immediately transmitting transmit-ready notifications, flagging anomalous notifications for further review, deprioritizing or blocking transmission of non-critical notifications, and suppressing duplicative notifications from delivery.

As shown in block 308, the process flow 300 may include the step of blocking the first notification from transmission to the end-point device of the user upon identifying that the first notification is a non-critical notification. In example embodiments, the automated notification assessment and classification system may be configured to block one or more notifications, including the first notification, from being delivered to the user via the communication channel associated with the notification, in response to a determination by the agentic AI engine that the notification is a non-critical notification, thereby indicating that the notification is not required for immediate delivery to the user.

In some embodiments, the agentic AI engine may determine that the notification is a non-critical notification based on analysis of its content, context, and associated classification parameters. The agentic AI engine may evaluate the notification against previously fine-tuned criteria, such as user preferences, engagement history, semantic relevance, and timing sensitivity, to assess whether the notification lacks urgency or contextual significance. Notifications classified as non-critical may include informational messages, low-priority updates, or marketing content that does not require immediate user attention.

In some embodiments, the system may suppress or queue the non-critical notification for deferred delivery, or discard the notification entirely based on system policies or user-defined thresholds. Metadata comprising the notification content, channel assignment, classification outcome, and suppression reason may be stored in the notification repository database and used to further refine the agentic AI engine's classification process through periodic feedback learning.

In some embodiments, notifications classified as transmit-ready notifications may be transmitted to the end-point user device(s) 140 via the associated communication channel. Upon transmission of the notification, the system may be configured to monitor and record user response data associated with the transmitted notification, to the extent that such feedback is detectable within the operational context of the associated communication channel. The monitored response data may include, for example, acknowledgment, dismissal, or lack of engagement by the user. Tracking may include detecting whether the notification was opened, acknowledged, ignored, or dismissed, as well as capturing any user-initiated actions, such as marking the notification as suspicious or irrelevant. For instance, in embodiments involving email delivery, the system may be configured to detect user actions such as failure to open the email within a predefined time interval, designation of the message as spam or suspicious, or manual marking of the email as high importance. Similar indicators may be captured across other communication channels, including but not limited to deletion of a message prior to being read or verbal flagging of a message within an interactive voice response (IVR) system. The automated notification assessment and classification system may be further configured to store the transmitted notification along with associated metadata, such as the utilized communication channel, delivery timestamp, delivery status, and user response outcome, within the notification repository database. The system may utilize the stored interaction data to perform ongoing fine-tuning, validation, or refinement of the agentic AI engine, thereby improving subsequent notification classification and transmission decisions.

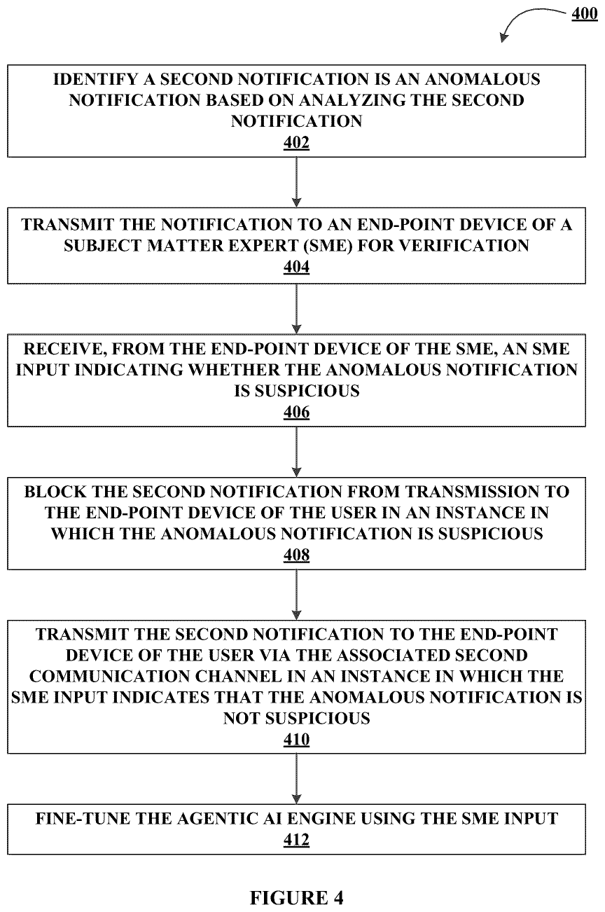

FIG. 4 illustrates a process flow 400 for notification classification and feedback, in accordance with an embodiment of the disclosure. In some embodiments, the automated notification assessment and classification system may perform one or more of the steps of process flow 400.

As shown in block 402, the process flow 400 may include the step of identifying a second notification is an anomalous notification based on analyzing the second notification. In some embodiments, the automated notification assessment and classification system may be configured to utilize the agentic AI engine to analyze and classify one or more notifications, including the second notification, as an anomalous notification, by transmitting the notifications received from the notification generation engine via the inter-process communication (IPC) channels. An anomalous notification refers to a message that deviates from expected patterns or content norms, potentially indicating corrupted data, an unexpected system event, or activity outside typical operational boundaries. The classification of anomalous notifications may further include notifications that exhibit characteristics suggestive of irregular, manipulated, or potentially misleading content, such as those generated under unusual conditions or containing attributes that raise concern regarding authenticity, source, or intent. The agentic AI engine may apply one or more anomaly detection criteria to identify such notifications, comprising semantic inconsistency with prior messages, structural abnormalities, unexpected timing or frequency, or deviations from known user or system activity. Upon classification, anomalous notifications may be flagged, suppressed, isolated for further review, or routed differently to prevent unintended delivery.

As shown in block 404, the process flow 400 may include the step of transmitting the second notification to an end-point device of a subject matter expert (SME) for verification. In example embodiments, the automated notification assessment and classification may be configured to send the anomalous notification, including the second notification, to a designated SME device, such as a review console, administrative dashboard, or expert communication interface, in response to the agentic AI engine classifying the notification as a suspicion-flagged or anomalous message. The SME may be prompted to evaluate the content, source, and contextual relevance of the notification and provide verification input indicating whether the notification should be transmitted to the user, suppressed, modified, or further investigated. The SME's feedback may be recorded and stored for training and refining the classification logic of the agentic AI engine through continuous feedback learning.

As shown in block 406, the process flow 400 may include the step of receiving, from the end-point device of the SME, an SME input indicating whether the anomalous notification is suspicious. In example embodiments, the automated notification assessment and classification system may be configured to receive an SME input from the end-point device of the SME. The SME input may include a classification decision confirming or rejecting the suspicion status of the anomalous notification, along with optional annotations, severity levels, or recommended handling actions. The system may process the SME input to update the classification status of the anomalous notification, influence downstream delivery decisions, or flag the notification for additional oversight.

In some embodiments, the SME input may be utilized as labeled feedback data for retraining or fine-tuning the agentic AI engine using supervised learning, reinforcement learning, or a combination thereof. The updated training or fine-tuning may enhance the accuracy, responsiveness, and adaptability of the agentic AI engine with respect to subsequent anomaly detection and classification operations.

As shown in block 408, the process flow 400 may include the step of blocking the second notification from transmission to the end-point device of the user in an instance in which the anomalous notification is suspicious. In example embodiments, upon receiving confirmation from the SME or based on a classification outcome generated by the agentic AI engine that satisfies a predefined confidence threshold, the system may be configured to suppress transmission of the suspicious notifications, including the second notification, and record the suspicious notifications as blocked in the notification repository database. The system may further store suppression-related metadata, including the detected anomaly type, classification confidence score, or SME input, and associate such metadata with the corresponding notification record to support auditability and future model training operations. The suppression process may prevent dissemination of inaccurate or inappropriate content, minimize user confusion, and ensure that only verified or contextually relevant notifications are delivered to the user.

As shown in block 410, the process flow 400 may include the step of transmitting the second notification to the end-point device of the user via the associated second communication channel in an instance in which the SME input indicates that the anomalous notification is not suspicious. In example embodiments, the system may reclassify the notifications, including the second notification, as transmit-ready notifications based on verification input received from the SME and initiate transmission of the notifications in accordance with a standard delivery protocol. Metadata indicating the prior anomaly classification, SME verification result, and transmission outcome may be stored in the notification repository database. The stored record may facilitate traceability, support compliance auditing requirements, and contribute to the enhancement of the agentic AI engine through feedback-based learning processes, thereby improving the system's classification accuracy for future notifications exhibiting similar characteristics.

As shown in block 412, the process flow 400 may include the step of fine-tuning the agentic AI engine using the SME input. In some embodiments, input received from the SME, indicating whether the anomalous notification is suspicious or non-suspicious, may be used as labeled feedback and incorporated into the training or fine-tuning dataset of the agentic AI engine. The system may update one or more classification parameters, including but not limited to anomaly detection thresholds, semantic similarity scores, or channel-specific behavioral pattern indicators, to enhance the AI model's ability to differentiate between valid and anomalous notifications in subsequent classifications. The updated training data may be used to adjust model weights, refine feature representations, or retrain specific layers of the AI model using supervised learning, reinforcement learning, or a combination thereof. In certain embodiments, the fine-tuning process may be executed on a periodic basis or dynamically in response to the accumulation of SME inputs, thereby enabling the agentic AI engine to evolve in accordance with expert feedback and adapt to changing operational conditions.

In some embodiments, the agentic AI engine may be configured to determine that a notification is duplicative based on analysis of its content, metadata, and associated transmission history. The agentic AI engine may evaluate the notification against previously delivered or queued messages to identify semantic similarity, contextual overlap, or structural redundancy. Such evaluation may include comparing message content, subject matter, originating source, or time of delivery within a predefined temporal window. For instance, notifications conveying substantially the same information, such as repeated status updates, confirmations, or acknowledgments, may be flagged as duplicative. The system may be configured to delay transmission of the notification to the end-point device of the user for a predetermined time upon determining that the notification is duplicative. This delay may serve to reduce user fatigue, prevent unnecessary disruptions, and allow for potential consolidation with future related notifications. In some embodiments, the notification may be re-evaluated after the delay period to determine whether it remains relevant or should be suppressed. Metadata associated with the duplicative classification and delay action may be recorded in the notification repository database to support ongoing refinement of classification logic through feedback learning.

In some embodiments, a feedback learning process may be implemented to evaluate and refine the classification accuracy of the agentic artificial intelligence (AI) engine with respect to notifications categorized as non-critical or duplicative. The system may be configured to direct such classified notifications, or a representative subset thereof, to a feedback module comprising one or more of SMEs, rule-based validation engines, or automated auditing components. The feedback module may be configured to assess whether the classification result, including suppression or delayed transmission, conforms to contextual appropriateness in view of user expectations or applicable operational guidelines. Resulting feedback may be recorded as labeled confirmation or correction data and integrated into the training dataset associated with the agentic AI engine. In some embodiments, the feedback data may be weighted based on one or more of: a confidence level associated with the feedback source, identified patterns of classification inconsistency, or prior accuracy associated with feedback sources. The labeled data may be used to fine-tune internal model parameters, including classification thresholds, neuron activations, or feature weighting factors. Over time, the feedback learning mechanism may enable the agentic AI engine to increase accuracy in classifying non-critical or duplicative notifications, thereby reducing false suppressions while preserving communication relevance.

In some embodiments, the system may be configured to receive user feedback from the end-point device of the user associated with the transmission of the notification via the communication channel. The user feedback may comprise explicit responses, such as marking the notification as helpful, irrelevant, unnecessary, or suspicious, as well as implicit activity pattern indicators, such as response latency, dismissal behavior, or frequency of engagement. The feedback may be collected through interactive interfaces, in-app responses, or embedded controls within the communication channel. Upon receiving the user feedback, the system may be further configured to fine-tune the agentic AI engine using the received data. The fine-tuning process may include updating one or more classification parameters, modifying notification prioritization scores, or adjusting threshold values associated with urgency, relevance, or redundancy. The user feedback data may be stored in the notification repository database and incorporated into scheduled training cycles to refine the classification logic of the agentic AI engine, thereby enhancing its capability to dynamically adapt notification handling in accordance with evolving user preferences and activity pattern trends.

In some embodiments, the automated notification assessment and classification system may be configured to utilize a hierarchical architecture for deploying and managing agentic AI models used in the notification classification and delivery decision-making process. The hierarchical architecture may be implemented based on one or more deployment strategies, selected in accordance with system configuration parameters, computational resource constraints, and user-specific personalization requirements.

In some embodiment, the automated notification assessment and classification system may employ a centralized generalized agentic AI engine configured to handle classification tasks across multiple users. The centralized engine may function as a core inference model trained on a comprehensive dataset that includes aggregated notification behaviors and interaction patterns across a plurality of users. To enable user-level personalization, the system may associate each user with a corresponding set of user-specific parameters, representation vectors, or interactional embeddings that encode learned user preferences, historical behavioral data, and relevant contextual attributes. Upon receiving a notification targeted to a specific user, the system may retrieve the user-associated data and incorporate it into the real-time inference process, thereby enabling tailored classification outcomes without instantiating a dedicated model instance for each individual user.

In some embodiments, the system may be configured to deploy individualized instances of the agentic AI engine for each user. Each user-specific instance may originate from a common base model and may be subsequently fine-tuned using notification history, interaction response patterns, and contextual signals uniquely associated with the corresponding user. The system may allocate dedicated computational or memory resources to support each individualized instance and may execute ongoing model refinement through periodic or event-driven fine-tuning processes. The per-user model configuration may facilitate heightened personalization and may be particularly applicable in high-sensitivity domains characterized by significant inter-user behavioral variance. The plurality of individualized models may be orchestrated and maintained by a centralized model management component configured to oversee model instantiation, lifecycle operations, feedback assimilation, and performance monitoring.

In some embodiments, the system may implement a hybrid architecture that combines the scalability of a centralized agentic AI model with user-specific personalization components. In such embodiments, the agentic AI engine may be configured to utilize shared backbone layers to perform base-level inference and apply user-specific modifiers, including but not limited to learned user vectors, priority scoring functions, or rule-based weight mappings, at predetermined decision points within the classification pipeline. The hybrid configuration may enable dynamic adaptation of classification outcomes while maintaining reduced computational overhead, thereby facilitating efficient scalability across a large user base.

The selection among centralized, personalized, or hybrid architectures may depend on deployment environment, real-time processing requirements, security policies, and user data sensitivity. Regardless of the selected architecture, the automated notification assessment and classification system may be configured to adaptively align its AI-driven classification logic with user-specific activity patterns and evolving patterns of notification engagement.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for automated assessment and classification of notifications generated in a distributed network environment before transmission to an end-point device associated with a user, the system comprising:
a memory device with computer-readable program code stored thereon; and
a processing device operatively coupled to the memory device, wherein executing the computer-readable program code causes the processing device to:
receive a first notification and an associated first communication channel for transmission of the first notification to the user;
analyze, using an agentic artificial intelligence (AI) engine, the first notification using classification parameters, wherein the classification parameters are derived by fine-tuning the agentic AI engine using at least one of historical notification data associated with the user, patterns of previous user interactions across multiple communication channels, notification scoring parameters, and anomaly detection criteria;
identify the first notification is a non-critical notification based on analyzing the first notification; and
block the first notification from transmission to the end-point device of the user upon identifying that the first notification is a non-critical notification.

2. The system of claim 1, wherein the computer-readable program code, when executed, further causes the processing device to:
receive a second notification and an associated second communication channel for transmission of the second notification to the user;
analyze, using the agentic AI engine, the second notification using the classification parameters;
identify the second notification is an anomalous notification based on analyzing the second notification; and
transmit the second notification to the end-point device of a subject matter expert (SME) for verification.

3. The system of claim 2, wherein the computer-readable program code, when execute, further causes the processing device to:
receive, from the end-point device of the SME, an SME input indicating whether the anomalous notification is suspicious; and
block the second notification from transmission to the end-point device of the user in an instance in which the anomalous notification is suspicious.

4. The system of claim 3, wherein the computer-readable program code, when executed, further causes the processing device to:
transmit the second notification to the end-point device of the user via the associated second communication channel in an instance in which the SME input indicates that the anomalous notification is not suspicious.

5. The system of claim 3, wherein the computer-readable program code, which when executed, further causes the processing device to:
fine-tune the agentic AI engine using the SME input.

6. The system of claim 1, wherein the computer-readable program code, which when executed, further causes the processing device to:
receive a third notification and an associated third communication channel for transmission of the third notification to the user;
analyze, using the agentic AI engine, the third notification using the classification parameters;
identify the third notification is transmit-ready for transmission via the associated third communication channel based on analyzing the third notification; and
transmit the third notification to the end-point device of the user via the associated third communication channel upon determining that the third notification is transmit-ready.

7. The system of claim 6, wherein the computer-readable program code, when executed, further causes the processing device to:
receive, from the end-point device of the user, user feedback associated with the transmission of the third notification via the third communication channel; and
fine-tune the agentic AI engine using the received user feedback.

8. The system of claim 1, wherein the computer-readable program code, when executed, further causes the processing device to:
receive a fourth notification and an associated fourth communication channel for transmission of the fourth notification to the user;
analyze, using the agentic AI engine, the fourth notification using the classification parameters;
identify the fourth notification is duplicative based on analyzing the fourth notification; and
delay transmission of the fourth notification to the end-point device of the user for a predetermined time upon determining that the fourth notification is duplicative.

9. The system of claim 1, wherein the first communication channel comprises at least one of an email channel, short messages service (SMS), push notification, voice call, or In-application notification.

10. A computer program product for automated assessment and classification of notifications generated in a distributed network environment before transmission to an end-point device associated with a user, wherein the computer program product comprises at least one non-transitory computer-readable medium having computer-readable program code portion embodied therein, the computer-readable program code portions which when executed by a processing device are configured to cause a processor to:
receive a first notification and an associated first communication channel for transmission of the first notification to the user;
analyze, using an agentic artificial intelligence (AI) engine, the first notification using classification parameters, wherein the classification parameters are derived by fine-tuning the agentic AI engine using at least one of historical notification data associated with the user, patterns of previous user interactions across multiple communication channels, notification scoring parameters, and anomaly detection criteria;
identify the first notification is a non-critical notification based on analyzing the first notification; and
block the first notification from transmission to the end-point device of the user upon identifying that the first notification is a non-critical notification.

11. The computer program product of claim 10, wherein the processing device is further configured to:
receive a second notification and an associated second communication channel for transmission of the second notification to the user;
analyze, using the agentic AI engine, the second notification using the classification parameters;
identify the second notification is an anomalous notification based on analyzing the second notification; and
transmit the second notification to the end-point device of a subject matter expert (SME) for verification.

12. The computer program product of claim 11, wherein the processing device is further configured to:
receive, from the end-point device of the SME, an SME input indicating whether the anomalous notification is suspicious; and
block the second notification from transmission to the end-point device of the user in an instance in which the anomalous notification is suspicious.

13. The computer program product of claim 12, wherein the processing device is further configured to:
fine-tune the agentic AI engine using the SME input.

14. The computer program product of claim 10, wherein the processing device is further configured to:
receive a third notification and an associated third communication channel for transmission of the third notification to the user;
analyze, using the agentic AI engine, the third notification using the classification parameters;
identify the third notification is transmit-ready for transmission via the associated third communication channel based on analyzing the third notification; and
transmit the third notification to the end-point device of the user via the associated third communication channel upon determining that the third notification is transmit-ready.

15. The computer program product of claim 10, wherein the processing device is further configured to:
receive a fourth notification and an associated fourth communication channel for transmission of the fourth notification to the user;
analyze, using the agentic AI engine, the fourth notification using the classification parameters;
identify the fourth notification is duplicative based on analyzing the fourth notification; and
delay transmission of the fourth notification to the end-point device of the user for a predetermined time upon determining that the fourth notification is duplicative.

16. A computer-implemented method for automated assessment and classification of notifications generated in a distributed network environment before transmission to an end-point device associated with a user, the method comprising:
receiving a first notification and an associated first communication channel for transmission of the first notification to the user;
analyzing, using an agentic artificial intelligence (AI) engine, the first notification using classification parameters, wherein the classification parameters are derived by fine-tuning the agentic AI engine using at least one of historical notification data associated with the user, patterns of previous user interactions across multiple communication channels, notification scoring parameters, and anomaly detection criteria;
identifying the first notification is a non-critical notification based on analyzing the first notification; and
blocking the first notification from transmission to the end-point device of the user upon identifying that the first notification is a non-critical notification.

17. The computer-implemented method of claim 16, wherein the computer-implemented method is further configured for:
receiving a second notification and an associated second communication channel for transmission of the second notification to the user;
analyzing, using the agentic AI engine, the second notification using the classification parameters;
identifying the second notification is an anomalous notification based on analyzing the second notification; and
transmitting the second notification to the end-point device of a subject matter expert (SME) for verification.

18. The computer-implemented method of claim 17, wherein the computer-implemented method is further configured for:
receiving, from the end-point device of the SME, an SME input indicating whether the anomalous notification is suspicious; and
blocking the second notification from transmission to the end-point device of the user in an instance in which the anomalous notification is suspicious.

19. The computer-implemented method of claim 16, wherein the computer-implemented method is further configured for:
receiving a third notification and an associated third communication channel for transmission of the third notification to the user;
analyzing, using the agentic AI engine, the third notification using the classification parameters;
identifying the third notification is transmit-ready for transmission via the associated third communication channel based on analyzing the third notification; and
transmitting the third notification to the end-point device of the user via the associated third communication channel upon determining that the third notification is transmit-ready.

20. The computer-implemented method of claim 16, wherein the computer-implemented method is further configured for:
receiving a fourth notification and an associated fourth communication channel for transmission of the fourth notification to the user;
analyzing, using the agentic AI engine, the fourth notification using the classification parameters;
identifying the fourth notification is duplicative based on analyzing the fourth notification; and
delaying transmission of the fourth notification to the end-point device of the user for a predetermined time upon determining that the fourth notification is duplicative.
